(19) United States
(12) Patent Application Publication
(10) Pub. No.: US 2006/0004528 A1
(43) Pub. Date: Jan. 5, 2006

(54) Apparatus and method for extracting similar source code

(75) Inventors: Tadahiro Uehara, Kawasaki (JP); Toshiaki Yoshino, Kawasaki (JP); Masando Fujita, Kawasaki (JP); Ryuji Nakamura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/090,275

(22) Filed: Mar. 28, 2005

(30) Foreign Application Priority Data
Jul. 2, 2004 (JP) 2004-197317

(51) Int. Cl. G06F 17/30; G06F 19/00

(52) U.S. Cl. 702/20; 707/6

(57) ABSTRACT

In a similar source-code extracting apparatus, a comparison-source source-code fragment specifying unit accepts specification of a source-code fragment that is specified as a reference for comparison, a comparison-target source-code specifying unit accepts specification of a source code group and extracts a source-code fragment similar to the source-code fragment from the source code group, and a result output unit outputs the result of extraction. A comparison-target source-code fragment extracting unit extracts the source code to be compared for similarity with the comparison-source source-code fragment from the source code group, by referring to a syntax tree created from the comparison-source source-code fragment and a syntax tree created from the source code group. Also, a similar source-code extracting method and a computer readable recording medium in which a similar source-code extraction program for extracting a similar source-code fragment from a source code described in a predetermined programming language is recorded are disclosed.

### BACKGROUND OF THE INVENTION

1) Field of the Invention

The present invention relates to a technology for extracting a similar source code from source codes that are described in a predetermined programming language

2) Description of the Related Art

In software development projects, it is common to share functions such as a library commonly required for a program as a target for development, and to improve development efficiency and maintainability. However, some processes that should originally be shared are often included in individual programs from such a reason that there is no sufficient time for identifying and examining common functions in a design stage.

A technology of extracting a similar source-code fragment (or code clone) from a source code group has been known as a technology of slimming the unwieldy size of source codes due to common functions included, and enhancing maintainability. These technologies are embodied by manufacturing products as shown in “CCFinder/Gemini Web site”, [online], May 12, 2003, Osaka University, Graduate School of Information Science and Technology, Inoue laboratory, [Search: Jun. 22, 2004], Internet URL: http://sel.ics.es.osaka-u.ac.jp/cdtools/, “Semantic Designs, Inc: Clone Doctor”, [online], Semantic Designs, Inc., [Search: Jun. 22, 2004], Internet <URL: http://www.semdesigns.com/Products/Clone/>, and Non-patent literature 3: “BEB|Download”, [online], Blue Edge Bulgaria, [Search: Jun. 22, 2004], Internet URL: http://www.blue-edge.bg/download.html.

However, in the technology used for the products, all the source codes included in the source code group are compared with one another (round robin) to extract code clones. Therefore, if there are a large number of source codes in the source code group, the time for processing becomes enormous.

### SUMMARY OF THE INVENTION

It is an object of the present invention to solve at least the problems in the conventional technology.

A similar source-code extraction apparatus according to an aspect of the present invention is an apparatus for extracting a similar source-code fragment from a source code described in a predetermined programming language. The similar source-code extraction apparatus includes a first specification accepting unit that accepts specification of a comparison-source source-code fragment that is specified as a reference for similarity comparison; a second specification accepting unit that accepts specification of a comparison-target source code group from which a source-code fragment similar to the comparison-source source-code fragment is extracted; an extracting unit that extracts a comparison-target source-code fragment that is to be compared for similarity with the comparison-target source code fragment, from the comparison-target source code group; a similarity comparing unit that compares similarity between the comparison-source source-code fragment and the comparison-target source-code fragment, and calculates a degree of similarity; and an outputting unit that outputs degrees of similarity calculated in the form of a list.

A similar source-code extraction apparatus according to another aspect of the present invention is an apparatus for extracting a similar source-code fragment from a source code described in a predetermined programming language. The similar source-code extraction apparatus includes a first specification accepting unit that accepts specification of a comparison-source source-code that is specified as a reference for similarity comparison; a second specification accepting unit that accepts specification of a comparison-target source code group from which a source-code fragment similar to the comparison-source source-code is extracted; an extracting unit that extracts a comparison-target source-code fragment that is to be compared for similarity With the comparison-target source code fragment, from the comparison-target source code group; a similarity comparing unit that compares similarity between the comparison-source source-code fragment and the comparison-target source-code fragment, and calculates a degree of similarity; and an outputting unit that outputs degrees of similarity calculated in the form of a list.

A similar source-code extraction apparatus according to still another aspect of the present invention is an apparatus for extracting a similar source-code fragment from a source code described in a predetermined programming language. The similar source-code extraction apparatus includes a first specification accepting unit that accepts specification of a comparison-source source-code group that is specified as a reference for similarity comparison; a second specification accepting unit that accepts specification of a comparison-target source code group from which a source-code fragment similar to the comparison-source source-code group is extracted; an extracting unit that extracts a comparison-source source-code fragment from the comparison-source source code group, and extracting a comparison-target source-code fragment that is to be compared for similarity with the comparison-source source-code fragment, from the comparison-target source code group; a similarity comparing unit that compares similarity between the comparison-source source-code fragment and the comparison-target source-code fragment, and calculates a degree of similarity; and an outputting unit that outputs degrees of similarity calculated in the form of a list.

A similar source-code extracting method according to still another aspect of the present invention is a method of extracting a similar source-code fragment from a source code described in a predetermined programming language. The method includes accepting specification of a comparison-source source-code fragment that is specified as a reference for similarity comparison; accepting specification of a comparison-target source code group from which a source-code fragment similar to the comparison-source source-code fragment is extracted; extracting a comparison-target source-code fragment that is to be compared for similarity with the comparison-target source code fragment, from the comparison-target source code group; comparing similarity between the comparison-source source-code fragment and the comparison-target source-code fragment, and calculating a degree of similarity; and outputting degrees of similarity calculated in the form of a list.

A similar source-code extracting method according to still another aspect of the present invention is a method of extracting a similar source-code fragment from a source code described in a predetermined programming language. The method includes accepting specification of a comparison-source source-code that is specified as a reference for similarity comparison; accepting specification of a comparison-target source code group from which a source-code fragment similar to the comparison-source source-code is extracted; extracting a comparison-source source-code fragment from the comparison-source source code, and extracting a comparison-target source-code fragment that is to be compared for similarity with the comparison-target source code fragment, from the comparison-target source code group; comparing similarity between the comparison-source source-code fragment extracted and the comparison-target source-code fragment extracted, and calculating a degree of similarity; and outputting degrees of similarity calculated in the form of a list.

A similar source-code extracting method according to still another aspect of the present invention is a method of extracting a similar source-code fragment from a source code described in a predetermined programming language. The method includes accepting specification of a comparison-source source code group that is specified as a reference for similarity comparison; accepting specification of a comparison-target source code group from which a source-code fragment similar to the comparison-source source code group is extracted; extracting a comparison-source source-code fragment from the comparison-source source code group, and extracting a comparison-target source-code fragment that is to be compared for similarity with the comparison-source source-code fragment, from the comparison-target source code group; comparing similarity between the comparison-source source-code fragment extracted and the comparison-target source-code fragment extracted, and calculating a degree of similarity; and outputting degrees of similarity calculated in the form of a list.

The computer readable recording medium according to other aspects of the present invention store therein a computer program that causes a computer to execute the above similar source-code extracting methods according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram for explaining a background of a similar source-code extracting method according to a first embodiment of the present invention;

FIG. 2A is a diagram for explaining an overview of a conventional similar source-code extracting method;

FIG. 2B is a diagram for explaining an overview of the similar source-code extracting method according to the first embodiment;

FIG. 3 is a functional block diagram of a configuration of a similar source-code extracting apparatus according to the first embodiment;

FIG. 4 is a sample diagram of a selection screen for a comparison-source source-code fragment;

FIG. 5 is a sample diagram of a selection screen for a comparison-target source code;

FIG. 6 is a sample diagram of a parameter setting screen;

FIG. 7 is a sample diagram of a parameter-setting save screen;

FIG. 8 is a sample diagram of a parameter-setting selection screen;

FIG. 9 is a schematic diagram for explaining how to extract a comparison-target source-code fragment according to the first embodiment;

FIG. 10 is a schematic diagram for explaining how to calculate similarity between source codes according to the first embodiment;

FIG. 11 is a sample diagram of output results;

FIG. 12 is a flowchart of a process procedure for the similar source-code extracting apparatus as shown in FIG. 3;

FIG. 13 is a flowchart of a process procedure for calculating the similarity as shown in FIG. 12;

FIG. 14 is a functional block diagram of a configuration of a similar source-code extracting apparatus according to a second embodiment of the present invention;

FIG. 15 is a sample diagram of a source code setting screen;

FIG. 16 is a sample diagram of output results; and

FIG. 17 is a flowchart of a process procedure for the similar source-code extracting apparatus as shown in FIG. 14.

### DETAILED DESCRIPTION

Exemplary embodiments of a similar source-code extraction program, a similar source-code extracting apparatus, and a similar source-code extracting method according to the present invention are explained in detail below with reference to the accompanying drawings. Although the case of extracting a similar source-code fragment (or code clone) from a program described in C language is explained herein as an example, the present invention does not depend on a particular language, and can be used in various programming languages.

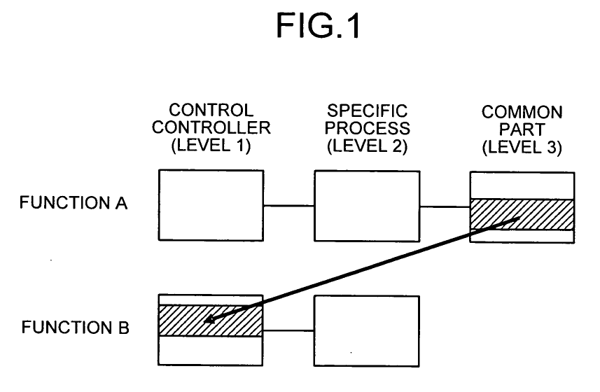

The background of a first embodiment of the present invention is explained below. FIG. 1 is a diagram for explaining the background of a similar source-code extracting method according to the first embodiment. Suppose that there is a rule to construct a program in three hierarchical program levels in a certain software development project.

A level 3 that is the lowest hierarchy corresponds to a “common part” obtained by extracting a process common to programs. A level 2 that is a higher hierarchy than the level 3 corresponds to “specific process” including an operation logic required for individual programs. A level 1 that is the highest hierarchy corresponds to a “control controller” that calls up the function of “common part” or “specific process” to realize an operation as a program.

However, the rule of the three hierarchies is not always strictly followed. For example, when a function B as a new function is to be additionally developed, it is necessary to modify a part of the specifications of an existing “common part”. However, from a reason that the time required for examining how the modification of the specifications gives influences over another program is short, the process requiring the modification of the specifications of the “common part” is incorporated into “control controller” of the function B, and the specifications are modified.

As a result of accumulation of these operations, the process the same as “common part” may be included in the “control controller” and the “specific process”, which makes it impossible to identify which of the processes is redundant. If any inconvenience is found in the “common part”, it is necessary to check the “control controller” and the “specific process” because the similar process may be present in the “control controller” and the “specific process”. If the similar code is present therein, it is also necessary to correct the similar code.

In a general project, it is not unusual that a similar code lies scattered in some parts of source codes in the project. For example, a variety of new services are provided over the Internet recently. These services are required to be provided to clients as quickly as possible, and therefore, a period allocated to development thereof is often very short. Consequently, the services not properly designed are packaged, and accordingly, sharing of the common process is not sometimes adequately performed.

When the source code in the project is in such a state, there are two countermeasures to be taken against the state. A first coutermeasure is a method of re-extracting a common process from all the source codes in the project, adequately sharing it as a common part, and rewriting an existing source code so as to call up the common part. A second countermeasure is a method of keeping a redundant code as it is without re-constructing the source code.

Originally, it is desirable to take the first countermeasure. The conventional similar source-code extracting method is targeted to support this operation. However, to perform this operation, all the programs in the project need to be checked again in addition to modification of the source code. As a result, the first countermeasure cannot be realized in many cases from the viewpoint of theman-hours.

Therefore, the second countermeasure is often taken in actual cases. However, when the second countermeasure is taken, it is necessary to check, each time an inconvenience is found in a part of the process, whether there is any other process similar to the process. If the similar process is present, this process needs correction. If the project is a large scale one, it is difficult to visually check all the programs and to determine whether the similar process is present therein. The similar source-code extracting method according to the first embodiment has a purpose to make the operation more efficiently.

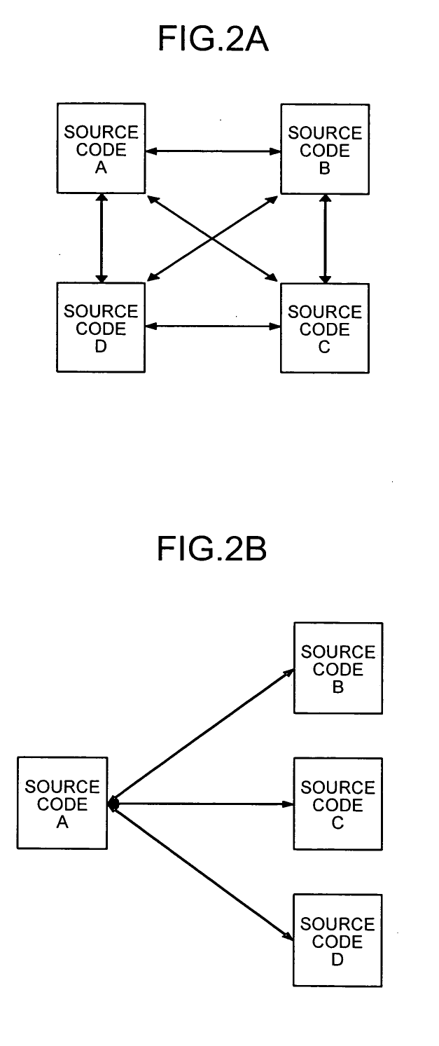

FIG. 2A is a diagram for explaining an overview of the conventional similar source-code extracting method. In the conventional similar source-code extracting method, all the source codes are compared with one another to extract a code clone. This method allows extraction of an unspecified large number of code clones, but if the number of the source codes increases, the time required for extraction increases exponentially.

This method is useful if the first countermeasure is taken because the similar code can be extracted from the whole source codes in the project, but if the second countermeasure is taken, such problems as explained below will come up. When the second countermeasure is taken, it is necessary to extract a code clone each time an inconvenience is found in a part of the process, and the time required for extraction in this processing method may be too long to go ahead with the operation efficiently.

If the purpose is to find out a portion similar to a portion where the inconvenience is found, the process of extracting a code clone is speeded up. Because if a portion similar to the portion with the inconvenience found is found out, only a source-code fragment similar to the portion may be extracted and an unspecified large number of code clones are not necessary to be extracted.

FIG. 2B is a diagram for explaining an overview of the similar source-code extracting method according to the first embodiment. In the similar source-code extracting method, a specific source code is defined as a reference, and the source code as the reference is compared with another source code, and a code clone is extracted. In this method, the code clone to be extracted is limited to a source code similar to the source code as the reference. Therefore, even if the number of source codes increases, the processing time required for extraction increases simply in proportion to the number of the source codes. Thus, the result of processing can be obtained at high speed.

If the processing speed is high, it becomes easy to extract a more appropriate code clone by adjusting a determination logic used to determine similarity, based on trial-and-error, according to features of a source code. The source codes have individual features such that some of them have a complicated control structure and some of them include a large number of data items. Therefore, by changing setting parameters for determining the degree of similarity so as to match the feature, the processing result satisfying the purpose can be obtained.

In the similar source-code extracting method according to the present invention, one of the purposes is to extract a source-code fragment similar to a portion where modification or correction is applied. However, the purpose of the use of the similar source-code extracting method is not limited thereto, and the present invention can be used for various purposes.

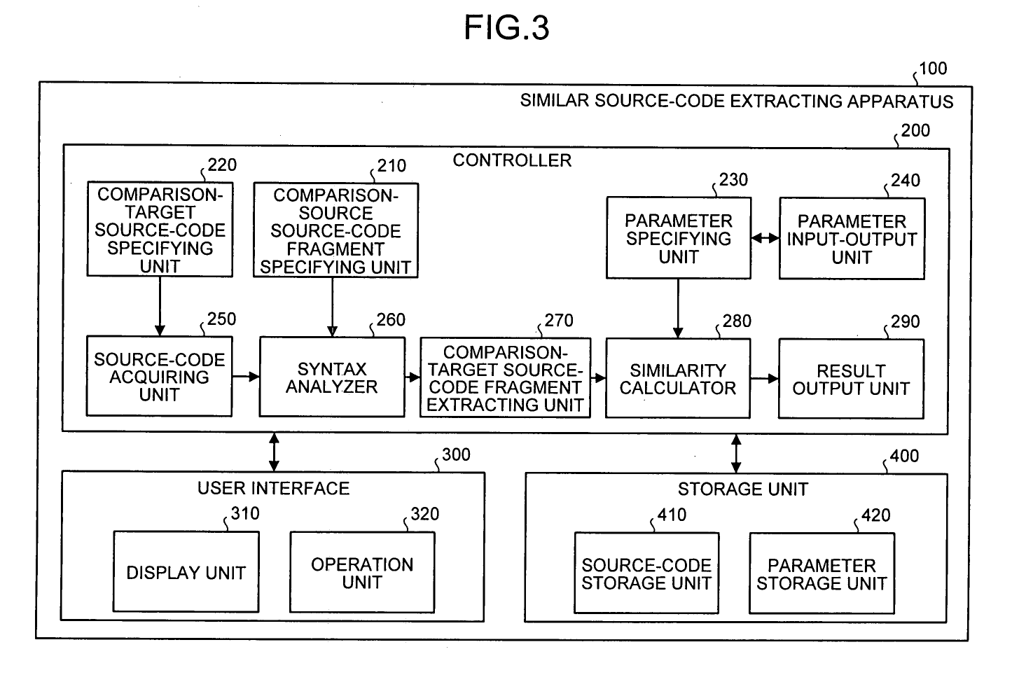

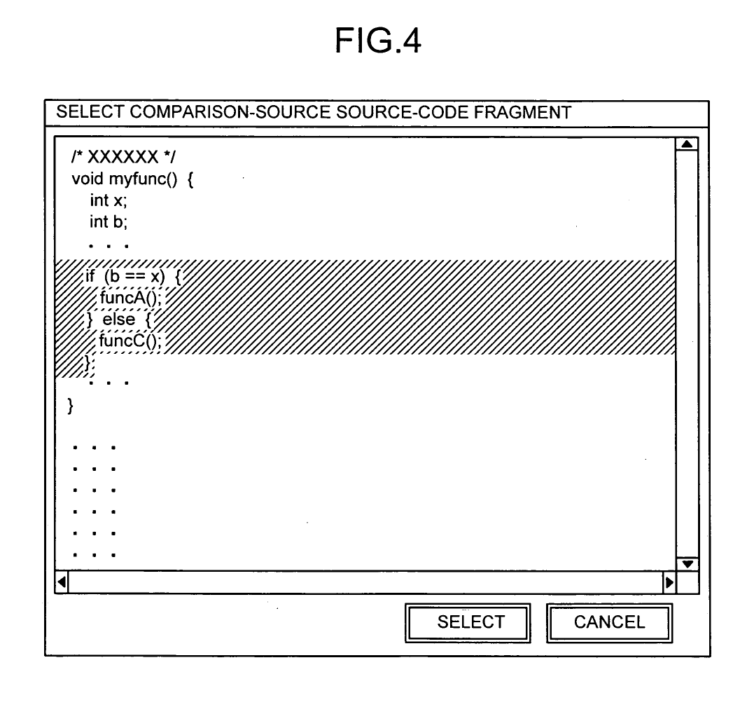

The configuration of the similar source-code extracting apparatus according to the first embodiment is explained below. FIG. 3 is a functional block diagram of the configuration of the similar source-code extracting apparatus according to the first embodiment. A similar source-code extracting apparatus 100 includes a controller 200, a user interface 300, and a storage unit 400.

The controller 200 controls the whole of the similar source-code extracting apparatus 100, and includes a comparison-source source-code fragment specifying unit 210, a comparison-target source-code specifying unit 220, a parameter specifying unit 230, a parameter input-output unit 240, a source-code acquiring unit 250, a syntax analyzer 260, a comparison-target source-code fragment extracting unit 270, a similarity calculator 280, and a result output unit 290.

The comparison-source source-code fragment specifying unit 210 is a processor that displays a selection screen for a comparison-source source-code fragment on a display unit 310, and accepts specification from a user for a source-code fragment that is specified as a reference for comparison.

FIG. 4 is a sample diagram of the selection screen for a comparison-source source-code fragment. The user causes an arbitrary source code to be displayed on a screen, selects a portion as a reference for comparison with a mouse or the like as an operation unit 320, and presses a “select” button. Through the operation, the comparison-source source-code fragment specifying unit 210 accepts the selected portion on the screen as a source-code fragment that serves as the reference for comparison.

The comparison-target source-code specifying unit 220 is a processor that displays a selection screen for a comparison-target source code on the display unit 310 and accepts specification from the user about an acquiring condition for a source code as a target for comparison.

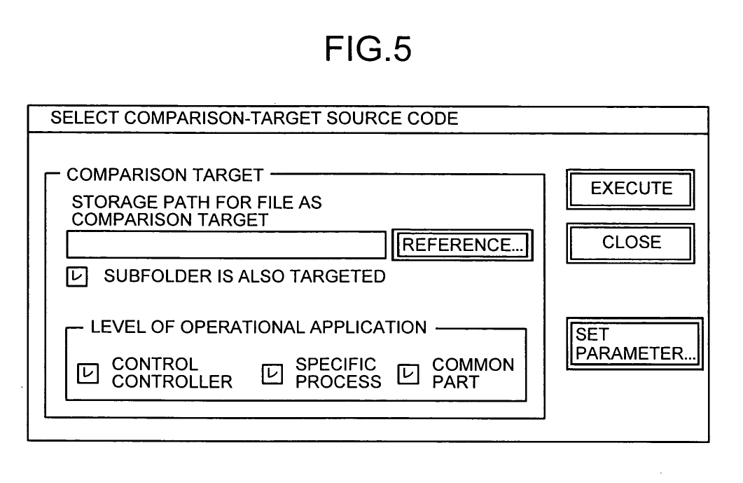

FIG. 5 is a sample diagram of the selection screen for a comparison-target source code. The user specifies a storage path for a folder including a source code as a target for comparison (hereinafter, “comparison target”). For specifying the storage path, the user presses a “reference” button to cause a hierarchical structure of the folder to be displayed on a screen for browsing, and the user can select a desired folder from the screen. The source code included in a subfolder of the folder specified is also a comparison target at default. However, if the user wants to exclude these source codes from the comparison target, the check on “subfolder is also targeted” is removed.

In the software development project according to the first embodiment, as shown in FIG. 1, the source codes are managed in the three hierarchies such as “control controller”, “specific process”, and “common part” as levels of operational application (FIG. 5). The source codes belonging to the respective hierarchies are stored in subfolders with names specified for the respective hierarchies. All source codes in the three hierarchies are comparison targets at default, but if the user wants to exclude a source code of a specific hierarchy from the comparison targets, the check on the corresponding hierarchy is removed.

When the user sets information required for an acquiring condition for a source code that is comparison target and presses an “execute” button, the comparison-target source-code specifying unit 220 accepts the information.

The parameter specifying unit 230 is a processor that displays a parameter setting screen on the display unit 310 and accepts specification from the user about parameter information to be used to determine the similarity between source-code fragments.

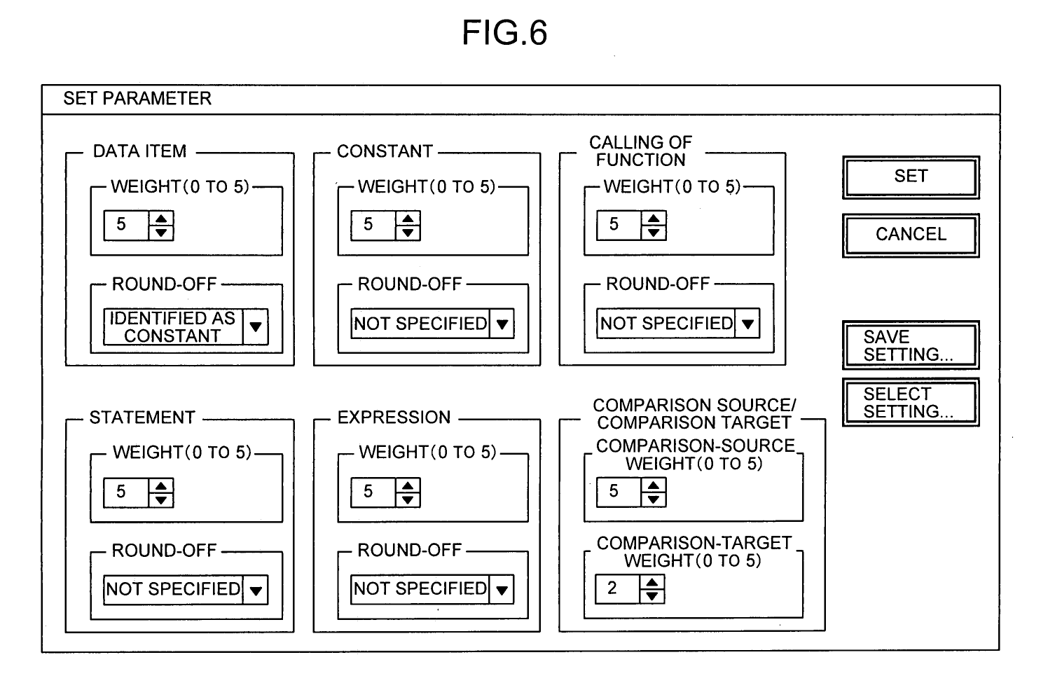

FIG. 6 is a sample diagram of the parameter setting screen. The user specifies “weight” and “round off” in each of “data item”, “constant”, “calling of a function”, “statement”, and “expression”. “Data item” indicates a variable, “constant” indicates a constant such as a numeric value or a character constant, “calling of a function” indicates calling of a function or a method, “statement” indicates a control statement or a control structure for conditional branching or a block, and “expression” indicates an operator.

“Weight” is a parameter for weighting a difference between the comparison source and the comparison target, and is specified by any one of numeric values of 0 to 5. The numeric value of 5 is a default value, and in the determination of the degree of similarity, a smaller numeric value is evaluated as a less difference. For example, if the similarity between the comparison source and the comparison target is to be determined by ignoring a difference between names of variable, the purpose is achieved by setting the weight of “data item” to zero.

The “round off” is used to specify a predetermined rule for changing a segment of “data item”, etc. For example, if a rule of “identified as a constant” is set in “data item”, even if an item is set as a variable in the comparison source and the item is set as a constant in the comparison target, these items are identified as one item.

The user specifies “weight” for the comparison source and the comparison target. The “weight” is specified by any of the numeric values of 0 to 5. The numeric value of 5 is a default value, and in the determination of the similarity, a smaller numeric value is evaluated as a less difference. For example, if the similarity between the comparison source and the comparison target is to be determined by ignoring an item that exists only in the comparison target, then the purpose is achieved by setting the weight of “comparison target” to zero.

When the user sets required parameter information and presses a “set” button, the parameter specifying unit 230 accepts the parameter information.

In the first embodiment, the elements of the source codes are classified into any one of “data item”, “constant”, “calling of a function”, “statement”, and “expression”, and the similarity is determined. However, in the similar source-code extracting method according to the present invention, the elements of the source codes are not necessarily classified in the above manner, and therefore, the classification may be performed using any other system.

The parameter input-output unit 240 is a processor that stores the parameter information input on the parameter setting screen in a parameter storage unit 420 in order to reuse it, and reads it therefrom as required.

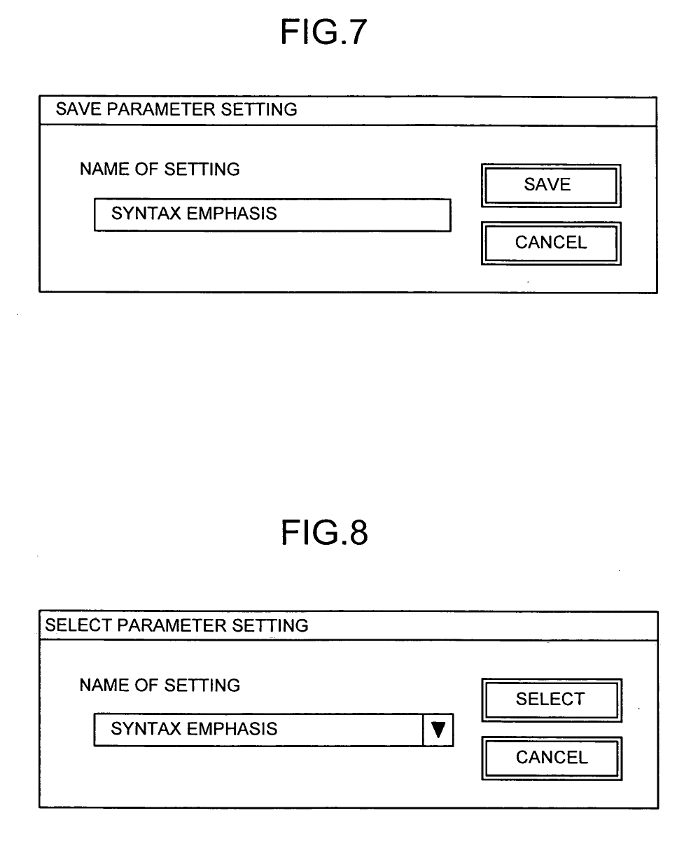

FIG. 7 is a sample diagram of a parameter-setting save screen. This screen is displayed by the parameter input-output unit 240 when a “save setting” button is pressed on the parameter setting screen. When the user inputs any name on this screen and presses the “save” button, the parameter input-output unit 240 adds the name to the parameter information input and stores it in the parameter storage unit 420.

FIG. 8 is a sample diagram of a selection screen for parameter setting. This screen is displayed by the parameter input-output unit 240 when a “select setting” button is pressed on the parameter setting screen. When the user selects a name of the parameter information that has been saved on this screen and presses the “select” button, the parameter input-output unit 240 reads the corresponding parameter information from the parameter storage unit 420 and displays it on the parameter setting screen.

The source-code acquiring unit 250 is a processor that acquires a source code as a comparison target from a source-code storage unit 410 based on the acquiring condition specified in the comparison-target source-code specifying unit 220. More specifically, the source-code acquiring unit 250 acquires a file that is specified as a target for comparison one by one, out of files present in a path specified, and transmits the file to the syntax analyzer 260.

The syntax analyzer 260 is a processor that analyzes the syntax of a source-code fragment specified by the comparison-source source-code fragment specifying unit 210 and the syntax of a source code as a comparison target included in the file acquired by the source-code acquiring unit 250, and creates syntax trees.

The comparison-target source-code fragment extracting unit 270 is a processor that extracts a syntax tree that is a target for similarity comparison with a comparison-source source-code fragment from the syntax trees of the comparison-target source code created by the syntax analyzer 260. In the similar source-code extracting method according to the first embodiment, a source-code fragment similar to the source-code fragment that is a comparison source is extracted from a source code as a comparison target. Therefore, the processing speed of extracting a similar source code largely fluctuates depending on how to extract a source-code fragment from the comparison-target source code.

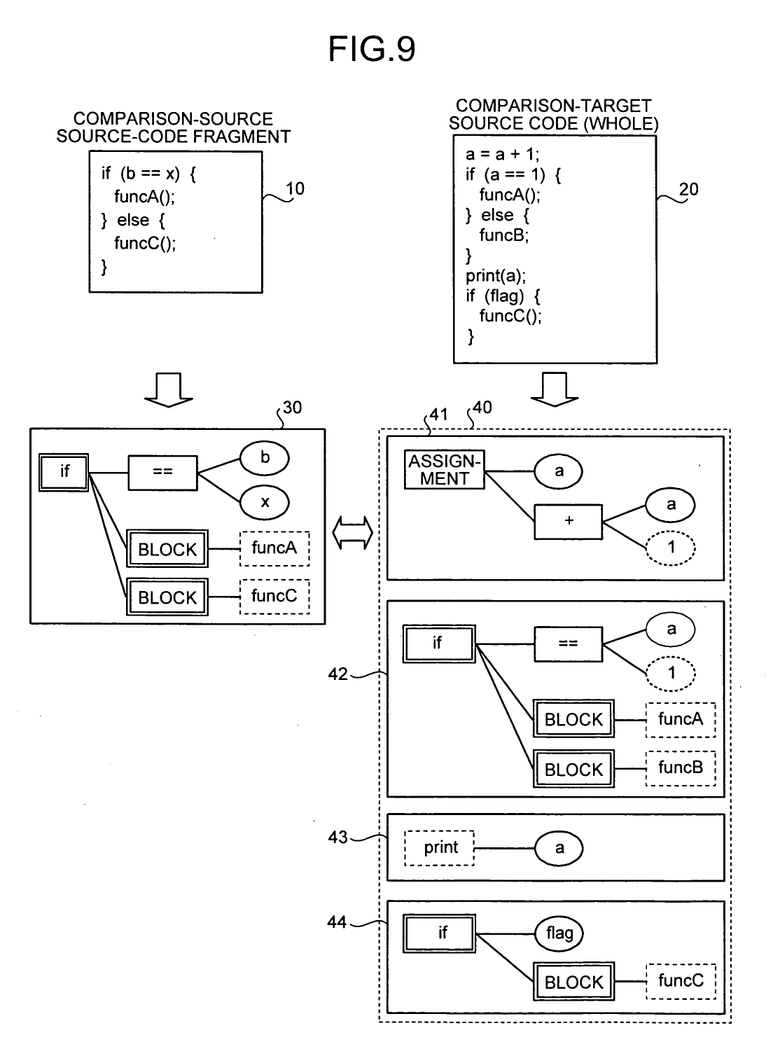

FIG. 9 is a schematic diagram for explaining how to extract a comparison-target source-code fragment according to the first embodiment. The source-code acquiring unit 250 analyzes syntaxes of a comparison-source source-code fragment 10 and a comparison-target source code 20, and creates a syntax tree 30 of the comparison-source source-code fragment and a syntax tree 40 of the comparison-target source code.

Since the comparison-source source-code fragment 10 has blocks including “if statement”, a syntax tree with “if” at the top thereof is created. Functions of the comparison-target source code 20 are largely divided into four blocks or statements, and four syntax trees 41, 42, 43, and 44 of the comparison-target source-code fragments (FIG. 9) are created.

The comparison-target source-code fragment extracting unit 270 extracts a syntax tree of which top is the same as the top of the syntax tree of the comparison-source source-code fragment, out of the syntax trees created from the comparison-target source code. The syntax tree thus extracted is used as a target for similarity comparison. As shown in FIG. 9, since the top of the syntax tree 30 of the comparison-source source code fragment is “if”, the syntax tree with “if” at the top thereof, out of the syntax trees 41, 42, 43, and 44 in the syntax tree 40, is a target for similarity comparison.

By comparing the tops of the syntax trees in the above manner to decide whether a particular syntax tree is specified as a target for similarity determination, a syntax tree that is specified as a target for similarity determination can be extracted quickly, and a similar source code can be extracted at high speed. The similar source-code extracting method according to the present invention dose not necessarily require the method of extracting the comparison-target source-code fragment explained herein. Therefore, any other extracting method can be also used.

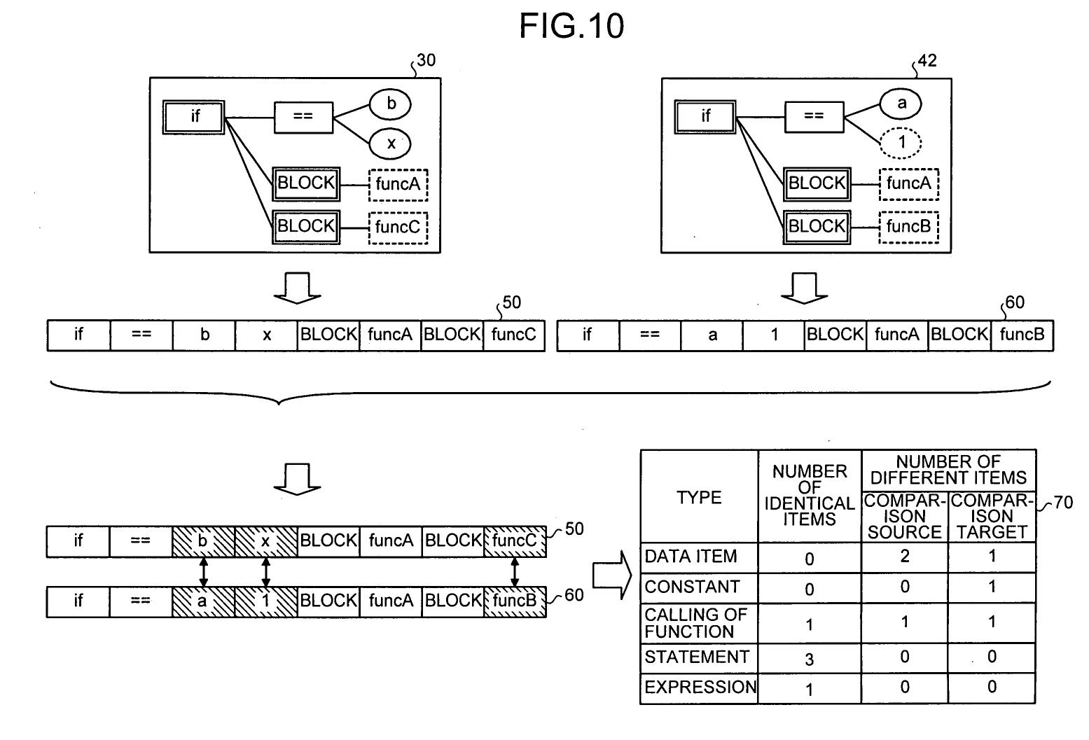

The similarity calculator 280 is a processor that compares the syntax tree created from the comparison-source source-code fragment with one of the syntax trees extracted as a target for similarity comparison by the comparison-target source-code fragment extracting unit 270, and that calculates the degree of similarity. FIG. 10 is a schematic diagram for explaining how to calculate the degree of similarity between the source codes according to the first embodiment.

As shown in FIG. 10, the similarity calculator 280 creates a sequence 50 in which elements of the syntax tree 30 of the comparison-source source code fragment are arranged in order of the appearance. The similarity calculator 280 creates a sequence 60 in which elements of a syntax tree 42 of the comparison-target source-code fragment are arranged in order of the appearance. The similarity calculator 280 compares the elements of the two sequences from the head thereof with each other, identifies whether the elements are the same as each other, and counts the number of items in which elements are the same as each other and the number of items in which elements are different from each other, by the type of the elements.

For example, both of the heads of the elements of the sequence 50 and the elements of the sequence 60 are “if” of the control statement. This case is regarded as one identical “statement” and is counted one. The fourth element of the sequence 50 is a variable “x” and the fourth element of the sequence 60 is a constant “1”. In this case, it is regarded that there is one difference in “data item” of the comparison source and there is one difference in “constant” of the comparison target, and both are counted in this manner.

If any of round-off rules is selected in the parameter specifying unit 230, elements are determined whether they are identical to each other in consideration of the round-off rule.

known algorisms used to determine identification of elements of two syntax trees include those described in (1) Sudarshan S. Chawathe, Anand Rajaraman, Hector Garcia-Molina, and Jenifer Widom, “Change detection in hierarchically structured information” in Proceedings of the ACM SIGMOD International Conference on Management of Data, pp. 493-504, 1996; (2) S. Chawathe, A. Rajaraman, H. Garcia-Molina, and J. Widom, “Change detection in hierarchically structured information,” available in http://dbpubs.stanford.edu:8090/aux/index-en.html, 1995. The identification may be determined using any of these algorisms.

The number of items counted in the above manner is assigned in expression (1), and degree of similarity R is calculated.

$$R = \frac{2 Σ ( Si \times Wi )}{2 Σ ( Si \times Wi ) + Σ ( Doi \times Wi \times Woi ) + 2 Σ ( Ddi \times Wi \times Wdi )} \qquad ( 1 )$$

Here, “i” is a type of an element of a sequence, i.e., “data item”, “constant”, “calling of a function”, “statement”, or “expression”. Si is the number of items of i that are determined as identical items between the comparison source and the comparison target. Wi is a weight of i specified in the parameter specifying unit 230. Doi is the number of items of i in a comparison source that are determined as different items therebetween. Woi is a value obtained by compressing the weight for the comparison source, specified in the parameter specifying unit 230, to a range from 0 to 1. More specifically, the weight specified as 4 in the parameter specifying unit 230 is used as 0.8. Ddi is the number of items of i in a comparison target that are determined as different items therebetween. Wdi is a value obtained by compressing the weight for the comparison source, specified in the parameter specifying unit 230, to a range from 0 to 1.

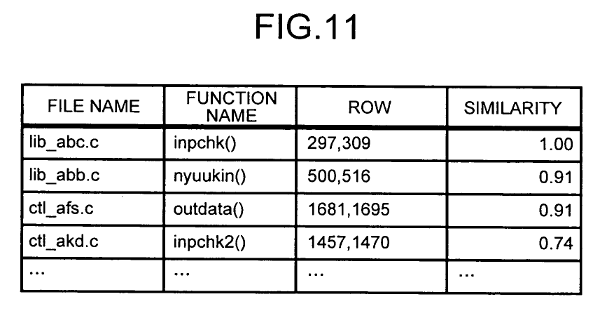

The result output unit 290 is a processor that sorts the results of calculation in the similarity calculator 280 in descending order and outputs the results. FIG. 11 is a sample diagram of the output results. Each of the output results consists of four items such as File name, Function name, Row, and Similarity.

The File name indicates a file name of a source code including a comparison-target source-code fragment. The Function name indicates a name of a function or a method including a comparison-target source-code fragment. The Row indicates a position of a comparison-target source-code fragment in source codes by a range of row numbers. The Similarity indicates a result of calculation in the similarity calculator 280.

The user interface 300 is a device that displays information for the user and accepts an instruction from the user. The user interface 300 includes the display unit 310 including a display such as a liquid crystal display, and the operation unit 320 including a keyboard and a mouse.

The storage unit 400 includes the source-code storage unit 410 and the parameter storage unit 420. The source-code storage unit 410 stores source codes from which a code clone is extracted. The parameter storage unit 420 stores various parameters specified in the parameter specifying unit 230 so as to be reusable.

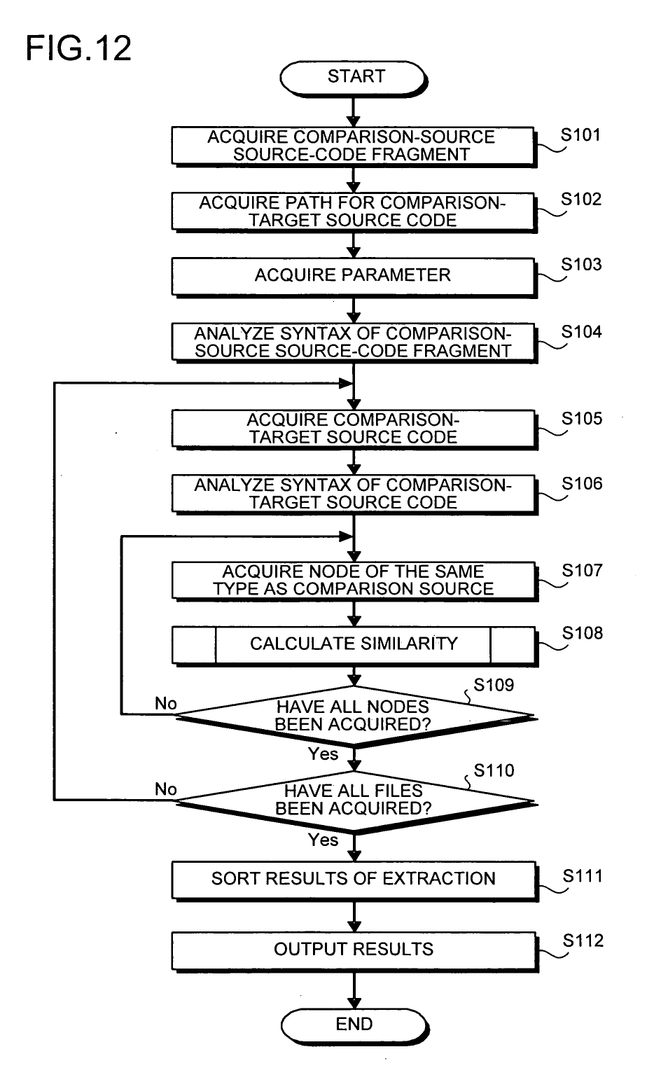

A process procedure for the similar source-code extracting apparatus 100 as shown in FIG. 3 is explained below. FIG. 12 is a flowchart of the process procedure for the similar source-code extracting apparatus as shown in FIG. 3.

As shown in FIG. 12, a source-code fragment specified as a comparison source is acquired through the comparison-source source-code fragment specifying unit 210 (step S101). An acquiring condition of a source-code fragment specified as a comparison target is acquired through the comparison-target source-code specifying unit 220 (step S102). Further, parameter information for similarity determination is acquired through the parameter specifying unit 230 (step S103).

When all pieces of the information required for the process are acquired in the above manner, the syntax analyzer 260 analyzes the syntax of the source-code fragment as the comparison source and creates a syntax tree of the comparison source (step S104).

The source-code acquiring unit 250 acquires one source code that matches the condition acquired in step S102 (step S105), and the syntax analyzer 260 analyzes the syntax of the source code and creates a syntax tree of the comparison-target source code (step S106).

The comparison-target source-code fragment extracting unit 270 extracts one syntax tree (or node) of which top is the same as that of the syntax tree of the comparison source, from the syntax trees of the comparison-target source code (step S107). The similarity calculator 280 compares the similarity between the syntax tree extracted and the syntax tree of the comparison source, and calculates the degree of similarity in a procedure as explained later (step S108).

If any syntax tree that is unprocessed and the top of which is the same as the top of the syntax tree of the comparison source remains in the comparison-target source codes (step S109, No), is the process is continued from step S107. If no syntax tree remains therein (step S109, Yes), then it is checked whether there remains any unprocessed source code that matches the condition acquired in step S102. If there remains any source code therein (step S110, No), then the process is continued from step S105.

If no source code remains (step S110, Yes), then the result output unit 290 sorts the results of calculation in the similarity calculator 280 in descending order of similarity (step S111), outputs the results sorted, and the process is completed (step S112).

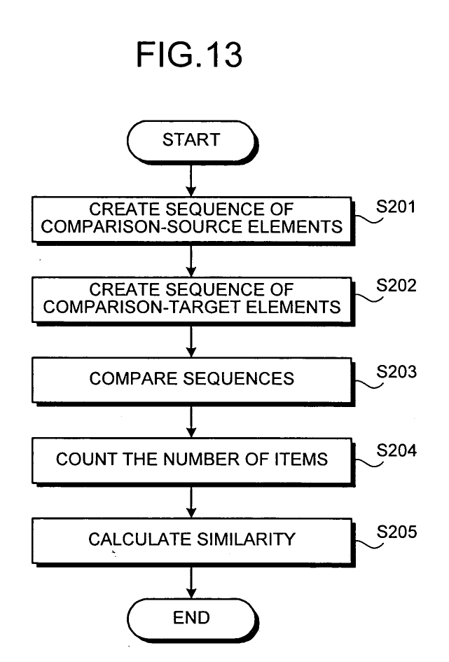

The process procedure for calculating similarity as shown in FIG. 12 is explained below. FIG. 13 is a flowchart of the process procedure for calculating the similarity as shown in FIG. 12.

The similarity calculator 280 creates a sequence in which elements of the syntax tree of the comparison source are arranged in order of the appearance (step S201). The similarity calculator 280 also creates a sequence in which elements of the syntax tree of the comparison target are arranged in order of the appearance (step S202). The similarity calculator 280 compares the two sequences with each other (step S203), and counts the number of identical items between the two and the number of different items between the two (step S204) for each type of items. The similarity calculator 280 assigns the results of counting in the expression (1) and calculates the similarity (step S205).

As explained above, in the first embodiment, an arbitrary portion of a source code is specified as a reference, and a source-code fragment similar to the reference is extracted from a source code group. Therefore, the processing result can be obtained at higher speed as compared with the case where all the source codes are compared with one another, for example, as shown in FIG. 2A.

In the first embodiment, the example of deciding an arbitrary portion of a source code as a reference and extracting a source-code fragment similar to this is explained. However, in the method as shown in the first example, if a plurality of source codes correspond to a reference, the process needs to be executed many times, which does not allow the process to work efficiently. For example, suppose a case where inconveniences of a plurality of source codes are to be corrected and a source-code fragment similar to any one of these source codes corrected is to be extracted.

In this case, it is convenient if a source code included in an arbitrary folder is specified as a comparison source and a source-code fragment similar to the source code can be extracted from another source code group. This method requires a longer time for extraction of a code clone than the method according to the first embodiment, but this method is executed at higher speed than the conventional method of examining all the source codes in a round robin method.

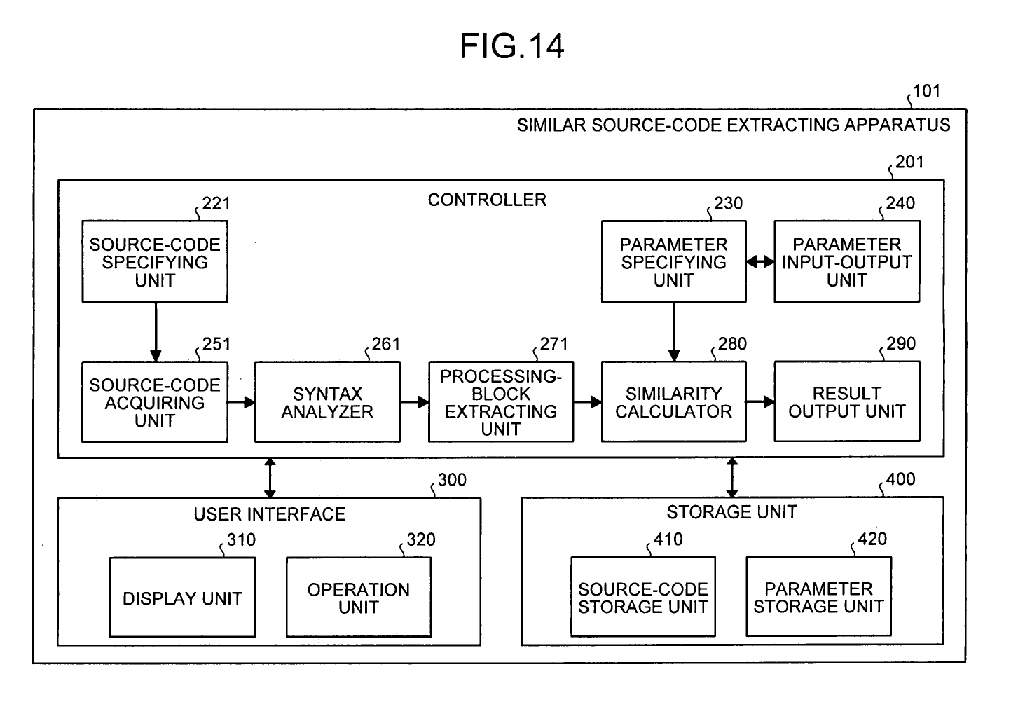

The configuration of the similar source-code extracting apparatus according to a second embodiment of the present invention is explained below. FIG. 14 is a functional block diagram of the configuration of the similar source-code extracting apparatus according to the second embodiment. Since the explanation for the first embodiment overlaps with that for the second embodiment, only a different portion is explained below.

As shown in FIG. 14, a similar source-code extracting apparatus 101 includes a controller 201, the user interface 300, and the storage unit 400.

The controller 201 controls the whole of the similar source-code extracting apparatus 101, and includes a source-code specifying unit 221, the parameter specifying unit 230, the parameter input-output unit 240, a source-code acquiring unit 251, a syntax analyzer 261, a processing-block extracting unit 271, the similarity calculator 280, and the result output unit 290.

The source-code specifying unit 221 is a processor that displays a selection screen for a source code on the display unit 310, and accepts specification from a user for acquiring conditions of source codes of a comparison source and a comparison target.

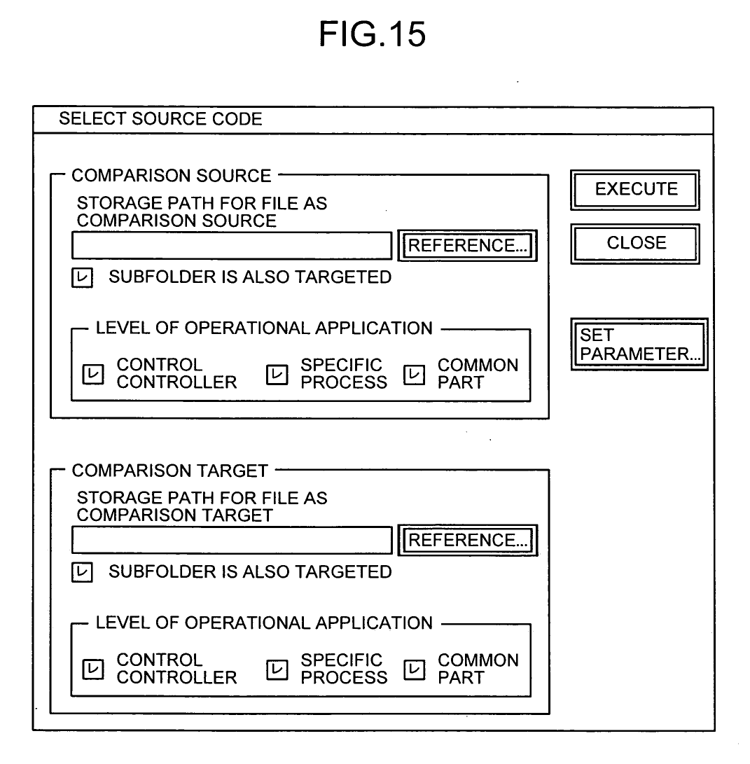

FIG. 15 is a sample diagram of the selection screen for a source code. This selection screen is provided by adding an item in the screen shown as the selection screen for the comparison-target source code of FIG. 5 in the first embodiment so that an acquiring condition of a comparison-source source code can be specified in the same manner as that in which an acquiring condition of a comparison-target source code is specified.

More specifically, the user can specify a path for a folder including a source code specified as a comparison target, and can specify a source code included in a subfolder of the folder so as to be outside the comparison target. The user can also specify a source code included in a particular hierarchy of the source codes managed in the three hierarchies so as to be outside the comparison target. The user can specify an acquiring condition of a source code specified as a comparison source in the above manner.

As for the comparison source, not a path for a folder including a source code, but a path for the source code itself may be specified.

The source-code acquiring unit 251 is a processor that acquires source codes as a comparison source and a comparison target from the source-code storage unit 410 based on the acquiring conditions specified in the source-code specifying unit 221.

The syntax analyzer 261 is the same as that of the first embodiment in terms of the function of analyzing the syntax of a source code and creating a syntax tree, but is different in that not a source-code fragment but the whole source code is analyzed upon analysis of a comparison-source source code.

The processing-block extracting unit 271 is a processor that extracts portions for similarity comparison from a syntax tree of a comparison-source source code created in the syntax analyzer 260 and a syntax tree of a comparison-target source code. More specifically, the processing-block extracting unit 271 extracts elements, function by function, from the syntax tree of the comparison-source source code and the syntax tree of the comparison-target source code.

In the similar source-code extracting method according to the second embodiment, similarity is determined by the function as a unit so that the sizes of a source-code fragment of a comparison source and a source-code fragment of a comparison target can be made uniform. If the source-code fragments are compared with each other by small units, e.g., by the statement or by the block, the number of processing times for similarity comparison increases, which reduces the processing speed. In addition, there is a possibility that many code clones will be output, so that the user will be unable to handle the outputs.

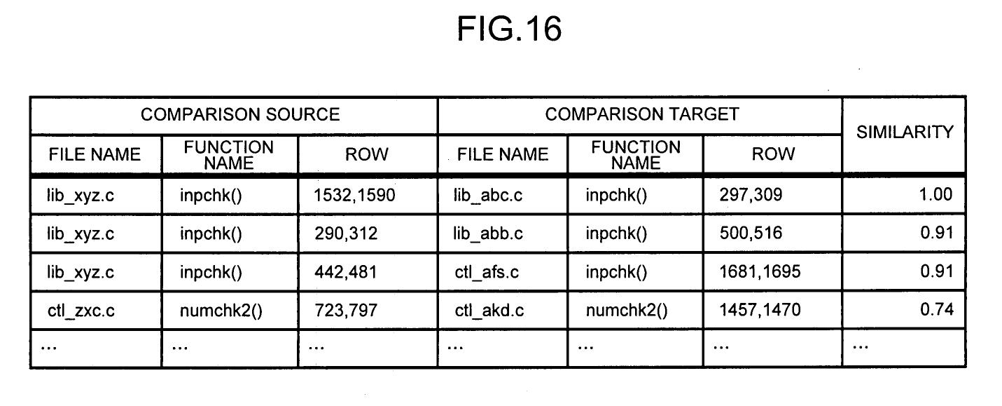

The result output unit 290 is a processor that sorts the results of calculation in the similarity calculator 280 in descending order of similarity and outputs the results sorted. FIG. 16 is a sample diagram of the output results. Each of the output results consists of seven items: File name, Function name, and Row for a comparison source; File name, Function name, and Row for a comparison target; and Similarity.

The File name indicates a file name of a source code including a source-code fragment. The Function name indicates a name of a function or a method including a source-code fragment. The Row indicates a position of a source-code fragment in source codes by a range of row numbers. The Similarity indicates the result of calculation in the similarity calculator 280.

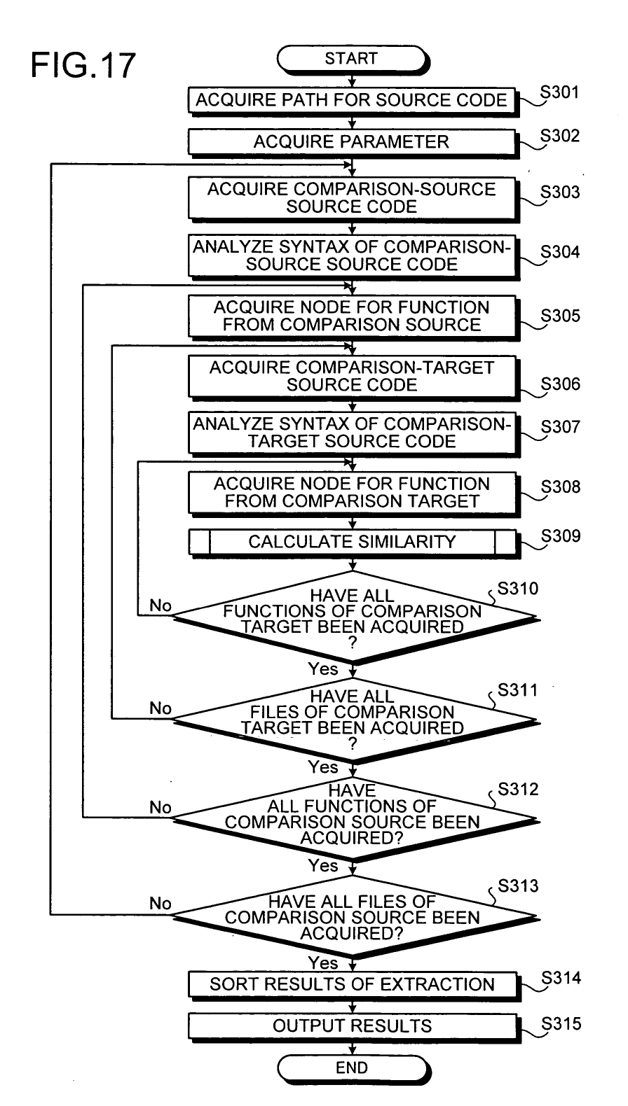

The process procedure for the similar source-code extracting apparatus 101 as shown in FIG. 14 is explained below. FIG. 17 is a flowchart of the process procedure for the similar source-code extracting apparatus 101 as shown in FIG. 14.

As shown in FIG. 17, the similar source-code extracting apparatus 101 acquires acquiring conditions of a source code specified as a comparison source and a source code specified as a comparison target, through the comparison-target source-code specifying unit 221 (step S301). Further, the similar source-code extracting apparatus 101 acquires parameter information for similarity determination through the parameter specifying unit 230 (step S302).

The source-code acquiring unit 251 acquires one source code of the comparison source that matches the condition acquired in step S301 (step S303), and the syntax analyzer 261 analyzes the syntax of the source code and creates a syntax tree of the comparison-source source code (step S304).

The processing-block extracting unit 271 extracts an element of one function from the syntax tree of the comparison-source source code created in the above manner (step S305).

The source-code acquiring unit 251 acquires one source code of the comparison target that matches the condition acquired in step S301 (step S306), and the syntax analyzer 260 analyzes the syntax of the source code and creates a syntax tree of the comparison-target source code (step S307).

The processing-block extracting unit 271 extracts an element of one function from the syntax tree of the comparison-target source code created in the above manner (step S308).

The similarity calculator 280 compares similarity between a function portion of the syntax tree of the comparison source extracted in step S305 and a function portion of the syntax tree of the comparison target extracted in step S308, and calculates the similarity in the procedure as explained with reference to FIG. 13 (step S309).

If any unprocessed function portion remains in the syntax tree of the comparison-target source code (step S310, No), the process is continued from step S308. If no syntax tree remains therein (step S310, Yes), then it is checked whether there remains in the comparison-target source code that matches the condition acquired in step S301, any source code the similarity of which is not compared with the source code of the current comparison source. If there remains the source code of the comparison target on which similarity comparison is not performed (step S311, No), then the process is continued from step S306. If there remains no comparison-target source code on which similarity comparison is not performed (step S311, Yes), then it is checked whether any unprocessed function portion remains in the syntax tree of the comparison-source source code. If any unprocessed function portion remains therein (step S312, No), then the process is continued from step S305. If no unprocessed function portion remains therein (step S312, Yes), then it is checked whether there remains any unprocessed source code of the comparison source that matches the condition acquired in step S301. If any unprocessed source code of the comparison source remains therein (step S313, No), then the process is continued from step S303.

If no unprocessed source code of the comparison source remains therein (step S313, Yes), the result output unit 290 sorts the results of calculation in the similarity calculator 280 in descending order of similarity (step S314), outputs the results, and completes the process (step S315).

As explained above, in the second embodiment, a source code included in an arbitrary folder is specified as a reference for comparison, and a source-code fragment similar to the reference is extracted from a source code group. Therefore, a plurality of source-code fragments can be specified as references and a code clone can be extracted. Thus, the processing result can be obtained at higher speed as compared with the case where all the source codes are compared with one another.

According to one aspect of the present invention, a source-code fragment specified is decided as a reference and a code clone is extracted. Therefore, as compared with the case where all the source codes are compared with one another for similarity comparison and code clones are extracted, the processing result can be obtained in a shorter time.

According to another aspect of the present invention, a source-code fragment included in one source code specified is decided as a reference and a code clone is extracted. Therefore, as compared with the case where all the source codes are compared with one another for similarity comparison and code clones are extracted, the processing result can be obtained in a shorter time.

According to still another aspect of the present invention, a source-code fragment included in a source code group specified is decided as a reference and a code clone is extracted. Therefore, as compared with the case where all the source codes are compared with one another for similarity comparison and code clones are extracted, the processing result can be obtained in a shorter time.

Furthermore, a parameter for adjusting a logic used to calculate the degree of similarity can be specified from the outside of the program. Therefore, a more appropriate similar source code can be extracted corresponding to features of the source code.

Moreover, the parameter for adjusting the logic can be stored in the storage unit and read from the storage unit as required. Therefore, the parameter specified can be re-used easily.

Furthermore, the source-code fragment is divided into elements, and the degree of similarity is calculated by weighting the elements for respective types of the elements. Therefore, a more appropriate similar source code can be extracted corresponding to features of the source code.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer readable recording medium that stores a computer program that causes a computer to extract a similar source-code fragment from a source code described in a predetermined programming language, the computer program causing the computer to execute:
accepting specification of a comparison-source source-code fragment that is specified as a reference for similarity comparison;
accepting specification of a comparison-target source code group from which a source-code fragment similar to the comparison-source source-code fragment is extracted;
extracting a comparison-target source-code fragment that is to be compared for similarity with the comparison-target source code fragment, from the comparison-target source code group;
comparing similarity between the comparison-source source-code fragment and the comparison-target source-code fragment, and calculating a degree of similarity; and
outputting degrees of similarity calculated in the form of a list.

2. The computer readable recording medium according to claim 1, wherein the computer program causes the computer to further execute
accepting specification of parameter information used to calculate the degree of similarity when calculating the similarity, wherein the degree of similarity is calculated in consideration of the parameter information accepted.

3. The computer readable recording medium according to claim 2, wherein the computer program causes the computer to further execute storing the parameter information accepted in combination with an arbitrary name in a storage unit.

4. The computer readable recording medium according to claim 3, wherein the computer program causes the computer to further execute reading the parameter information stored and transmitting the parameter information read to the accepting specification of parameter information.

5. The computer readable recording medium according to claim 1, wherein when calculating the similarity, each syntax of the comparison-source source-code fragment and the comparison-target source-code fragment is analyzed and is divided into elements, and the degree of similarity is calculated by adding a weight specified for each type of elements to a status of similarity or difference for each type of the elements.

6. The computer readable recording medium according to claim 5, wherein when accepting specification of parameter information, specification of the weight specified for each type of the elements is accepted.

7. The computer readable recording medium according to claim 1, wherein when calculating the similarity,
each syntax of the comparison-source source-code fragment and the comparison-target source-code fragment is analyzed and is divided into elements,
each status of similarity or difference in each type of the elements is acquired based on a predetermined rule for determining whether the elements are identical, and the degree of similarity is calculated.

8. The computer readable recording medium according to claim 7, wherein when accepting specification of parameter information, specification of the predetermined rule is accepted.

9. The computer readable recording medium according to claim 1, wherein when calculating the similarity,
each syntax of the comparison-source source-code fragment and the comparison-target source-code fragment is analyzed and is divided into elements,
each weight specified for the comparison-source source-code fragment and the comparison-target source-code fragment is added to respective statuses of similarity or difference in the comparison-source source-code fragment and the comparison-target source-code fragment, and
the degree of similarity is calculated.

10. The computer readable recording medium according to claim 9, wherein when accepting specification of parameter information, specification of the weight specified for each of the comparison-source source-code fragment and the comparison-target source code is accepted.

11. The computer readable recording medium according to claim 1, wherein when outputting degrees of similarity, the degrees of similarity calculated are output in descending order of similarity.

12. The computer readable recording medium according to claim 1, wherein when outputting the degrees of similarity, a file name of a source code and positional information for the source code are output together with the degrees of similarity calculated, the source code including the source-code fragment that is the target for calculation of the degree of similarity.

13. A computer readable recording medium that stores therein a computer program that causes a computer to extract a similar source-code fragment from a source code described in a predetermined programming language, the computer program causing the computer to execute:
accepting specification of a comparison-source source-code that is specified as a reference for similarity comparison;
accepting specification of a comparison-target source code group from which a source-code fragment similar to the comparison-source source-code is extracted;
extracting a comparison-source source-code fragment from the comparison-source source code, and extracting a comparison-target source-code fragment that is to be compared for similarity with the comparison-target source code fragment, from the comparison-target source code group;
comparing similarity between the comparison-source source-code fragment extracted and the comparison-target source-code fragment extracted, and calculating a degree of similarity; and
outputting degrees of similarity calculated in the form of a list.

14. The computer readable recording medium according to claim 13, wherein the computer program causes the computer to further execute
accepting specification of parameter information used to calculate the degree of similarity when calculating the similarity, wherein the degree of similarity is calculated in consideration of the parameter information accepted.

15. The computer readable recording medium according to claim 14, wherein the computer program causes the computer to further execute storing the parameter information accepted in combination with an arbitrary name, in a storage unit.

16. The computer readable recording medium according to claim 15, wherein the computer program causes the computer to further execute reading the parameter information stored and transmitting the parameter information read to the accepting specification of parameter information.

17. The computer readable recording medium according to claim 13, wherein when calculating the similarity, each syntax of the comparison-source source-code fragment and the comparison-target source-code fragment is analyzed and is divided into elements, and the degree of similarity is calculated by adding a weight specified for each type of elements to a status of similarity or difference for each type of the elements.

18. The computer readable recording medium according to claim 17, wherein when accepting specification of parameter information, specification of the weight specified for each type of the elements is accepted.

19. The computer readable recording medium according to claim 13, wherein when calculating the similarity,
each syntax of the comparison-source source-code fragment and the comparison-target source-code fragment is analyzed and is divided into elements,
each status of similarity or difference in each type of the elements is acquired based on a predetermined rule for determining whether the elements are identical, and
the degree of similarity is calculated.

20. The computer readable recording medium according to claim 19, wherein when accepting specification of parameter information, specification of the predetermined rule is accepted.

21. The computer readable recording medium according to claim 13, wherein when calculating the similarity,
each syntax of the comparison-source source-code fragment and the comparison-target source-code fragment is analyzed and is divided into elements,
each weight specified for the comparison-source source-code fragment and the comparison-target source-code fragment is added to respective statuses of similarity or difference in the comparison-source source-code fragment and the comparison-target source-code fragment, and
the degree of similarity is calculated.

22. The computer readable recording medium according to claim 21, wherein when accepting specification of parameter information, specification of the weight specified for each of the comparison-source source-code fragment and the comparison-target source code is accepted.

23. The computer readable recording medium according to claim 13, wherein when outputting degrees of similarity, the degrees of similarity calculated are output in descending order of similarity.

24. The computer readable recording medium according to claim 13, wherein when outputting the degrees of similarity, a file name of a source code and positional information for the source code are output together with the degrees of similarity calculated, the source code including the source-code fragment that is the target for calculation of the degree of similarity.

25. A computer readable recording medium that stores therein a computer program that causes a computer to extract a similar source-code fragment from a source code described in a predetermined programming language, the computer program causing the computer to execute:
accepting specification of a comparison-source source code group that is specified as a reference for similarity comparison;
accepting specification of a comparison-target source code group from which a source-code fragment similar to the comparison-source source code group is extracted;
extracting a comparison-source source-code fragment from the comparison-source source code group, and extracting a comparison-target source-code fragment that is to be compared for similarity with the comparison-source source-code fragment, from the comparison-target source code group;
comparing similarity between the comparison-source source-code fragment extracted and the comparison-target source-code fragment extracted, and calculating a degree of similarity; and
outputting degrees of similarity calculated in the form of a list.

26. The computer readable recording medium according to claim 25, wherein the computer program causes the computer to further execute
accepting specification of parameter information used to calculate the degree of similarity when calculating the similarity, wherein the degree of similarity is calculated in consideration of the parameter information accepted.

27. The computer readable recording medium according to claim 26, wherein the computer program causes the computer to further execute storing the parameter information accepted in combination with an arbitrary name, in a storage unit.

28. The computer readable recording medium according to claim 27, wherein the computer program causes the computer to further execute reading the parameter information stored and transmitting the parameter information read to the accepting specification of parameter information.

29. The computer readable recording medium according to claim 25, wherein when calculating the similarity, each syntax of the comparison-source source-code fragment and the comparison-target source-code fragment is analyzed and is divided into elements, and the degree of similarity is calculated by adding a weight specified for each type of elements to a status of similarity or difference for each type of the elements.

30. The computer readable recording medium according to claim 29, wherein when accepting specification of parameter information, specification of the weight specified for each type of the elements is accepted.

31. The computer readable recording medium according to claim 25, wherein when calculating the similarity,
each syntax of the comparison-source source-code fragment and the comparison-target source-code fragment is analyzed and is divided into elements,
each status of similarity or difference in each type of the elements is acquired based on a predetermined rule for determining whether the elements are identical, and
the degree of similarity is calculated.

32. The computer readable recording medium according to claim 31, wherein when accepting specification of parameter information, specification of the predetermined rule is accepted.

33. The computer readable recording medium according to claim 25, wherein when calculating the similarity,
each syntax of the comparison-source source-code fragment and the comparison-target source-code fragment is analyzed and is divided into elements,
each weight specified for the comparison-source source-code fragment and the comparison-target source-code fragment is added to respective statuses of similarity or difference in the comparison-source source-code fragment and the comparison-target source-code fragment, and
the degree of similarity is calculated.

34. The computer readable recording medium according to claim 33, wherein when accepting specification of parameter information, specification of the weight specified for each of the comparison-source source-code fragment and the comparison-target source code is accepted.

35. The computer readable recording medium according to claim 25, wherein when outputting degrees of similarity, the degrees of similarity calculated are output in descending order of similarity.

36. The computer readable recording medium according to claim 25, wherein when outputting the degrees of similarity, a file name of a source code and positional information for the source code are output together with the degrees of similarity calculated, the source code including the source-code fragment that is the target for calculation of the degree of similarity.

37. A similar source-code extraction apparatus for extracting a similar source-code fragment from a source code described in a predetermined programming language, comprising:
a first specification accepting unit that accepts specification of a comparison-source source-code fragment that is specified as a reference for similarity comparison;
a second specification accepting unit that accepts specification of a comparison-target source code group from which a source-code fragment similar to the comparison-source source-code fragment is extracted;
an extracting unit that extracts a comparison-target source-code fragment that is to be compared for similarity with the comparison-target source code fragment, from the comparison-target source code group;
a similarity comparing unit that compares similarity between the comparison-source source-code fragment and the comparison-target source-code fragment, and calculates a degree of similarity; and
an outputting unit that outputs degrees of similarity calculated in the form of a list.

38. A similar source-code extraction apparatus for extracting a similar source-code fragment from a source code described in a predetermined programming language, comprising:
a first specification accepting unit that accepts specification of a comparison-source source-code that is specified as a reference for similarity comparison;
a second specification accepting unit that accepts specification of a comparison-target source code group from which a source-code fragment similar to the comparison-source source-code is extracted;
an extracting unit that extracts a comparison-target source-code fragment that is to be compared for similarity with the comparison-target source code fragment, from the comparison-target source code group;
a similarity comparing unit that compares similarity between the comparison-source source-code fragment and the comparison-target source-code fragment, and calculates a degree of similarity; and
an outputting unit that outputs degrees of similarity calculated in the form of a list.

39. A similar source-code extraction apparatus for extracting a similar source-code fragment from a source code described in a predetermined programming language, comprising:
a first specification accepting unit that accepts specification of a comparison-source source-code group that is specified as a reference for similarity comparison;
a second specification accepting unit that accepts specification of a comparison-target source code group from which a source-code fragment similar to the comparison-source source-code group is extracted;
an extracting unit that extracts a comparison-source source-code fragment from the comparison-source source code group, and extracting a comparison-target source-code fragment that is to be compared for similarity with the comparison-source source-code fragment, from the comparison-target source code group;
a similarity comparing unit that compares similarity between the comparison-source source-code fragment and the comparison-target source-code fragment, and calculates a degree of similarity; and
an outputting unit that outputs degrees of similarity calculated in the form of a list.

40. A similar source-code extracting method for extracting a similar source-code fragment from a source code described in a predetermined programming language, comprising:
accepting specification of a comparison-source source-code fragment that is specified as a reference for similarity comparison;
accepting specification of a comparison-target source code group from which a source-code fragment similar to the comparison-source source-code fragment is extracted;
extracting a comparison-target source-code fragment that is to be compared for similarity with the comparison-target source code fragment, from the comparison-target source code group;
comparing similarity between the comparison-source source-code fragment and the comparison-target source-code fragment, and calculating a degree of similarity; and
outputting degrees of similarity calculated in the form of a list.

41. A similar source-code extracting method for extracting a similar source-code fragment from a source code described in a predetermined programming language, comprising:
accepting specification of a comparison-source source-code that is specified as a reference for similarity comparison;
accepting specification of a comparison-target source code group from which a source-code fragment similar to the comparison-source source-code is extracted;
extracting a comparison-source source-code fragment from the comparison-source source code, and extracting a comparison-target source-code fragment that is to be compared for similarity with the comparison-target source code fragment, from the comparison-target source code group;
comparing similarity between the comparison-source source-code fragment extracted and the comparison-target source-code fragment extracted, and calculating a degree of similarity; and
outputting degrees of similarity calculated in the form of a list.

42. A similar source-code extracting method for extracting a similar source-code fragment from a source code described in a predetermined programming language, comprising:
accepting specification of a comparison-source source code group that is specified as a reference for similarity comparison;
accepting specification of a comparison-target source code group from which a source-code fragment similar to the comparison-source source code group is extracted;
extracting a comparison-source source-code fragment from the comparison-source source code group, and extracting a comparison-target source-code fragment that is to be compared for similarity with the comparison-source source-code fragment, from the comparison-target source code group;
comparing similarity between the comparison-source source-code fragment extracted and the comparison-target source-code fragment extracted, and calculating a degree of similarity; and
outputting degrees of similarity calculated in the form of a list.
